(19) United States
(12) Patent Application Publication
(10) Pub. No.: US 2025/0050776 A1
(43) Pub. Date: Feb. 13, 2025

(54) ELECTRIC VEHICLE STATION MANAGEMENT SYSTEM

(71) Applicant: POWER-Q, Montreal (CA)

(72) Inventors: Ezatullah Alokozai, Montreal (CA); Lord Richy Duperron, Montreal (CA); Abdallah Mchirgui, Montreal (CA)

(21) Appl. No.: 18/800,328

(22) Filed: Aug. 12, 2024

Related U.S. Application Data
(60) Provisional application No. 63/518,730, filed on Aug. 10, 2023.

(51) Int. Cl. B60L 53/63; B60L 53/62; B60L 53/66; B60L 53/67; H02J 50/10

(52) U.S. Cl. CPC B60L 53/63; B60L 53/62; B60L 53/66; B60L 53/67; H02J 50/10

(57) ABSTRACT

A power regulator device, a power distribution device and related methods and systems for managing power consumption in electric vehicle supply equipment (EVSE) stations. The power regulator device includes an interconnector attached to an EVSE cable, a storage module for receiving a modulation configuration, and a filtering module for intercepting and altering the signal transmitted from the EVSE station to the electric vehicle. The power distribution device is configured to receive a load configuration and a list of EVSE controllers, measure the total load, and communicate modulation configurations to the EVSE controllers to manage power consumption. The system, designed to operate on a mesh network, includes multiple EVSE stations, power distribution devices, and a centralized monitoring agent for managing and controlling power consumption across the EVSE stations.

### PRIORITY STATEMENT

This non-provisional patent application claims priority based upon the prior U.S. provisional patent application entitled “ELECTRIC VEHICLE STATION MANAGEMENT SYSTEM”, application No. 63/518,730, filed on 2023 Aug. 10, in the name of POWER-Q, which is herein incorporated by reference in its entirety.

### TECHNICAL FIELD

The present invention relates to a power management system and, more particularly, to power management system for electric vehicle charger management.

### BACKGROUND

Energy requirements from electric vehicle chargers put high demands on circuits that were not necessarily designed for such purposes. This is particularly true when providing multiple charging stations to multiple electric vehicles. The present invention provides at least a partial solution to this problem.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first aspect, the technique described herein relates to a power regulator device for altering a signal transmitted over an electric vehicle supply equipment (EVSE) cable. The power regulator device comprises an interconnector that attaches to the EVSE cable, a storage module, and a filtering module. A front component of the interconnector leads to an electric vehicle and a back component leads to an EVSE station. The storage module receives a modulation configuration. The filtering module intercepts a signal from the EVSE station and outputs an altered signal towards the electric vehicle, thereby causing the electric vehicle to consume less power than by outputting the signal from the EVSE station. When the signal is a pulse-width modulation (PWM) signal, the filtering module may alter the signal by reducing the duty cycle of the PWM signal.

Alternatively, the power regulator device may further comprise a decoder module, a processor module and an encoder module. The decoder module may decode the signal from the EVSE station into a decoded signal, the processor module may compute the altered signal based on the decoded signal and the modulation configuration, and the encoder module may encode the altered PWM signal towards the electric vehicle.

Additionally, or alternatively, the power regulator device may further comprise a communication module configured to communicate with a power management device, the power management device comprising a power distribution device or a central monitoring agent. The communication module may receive a modulation configuration and transmit measurements from and to the power management device. The communication module may be configured to communicate in at least one configuration mode comprising power-line communication or wireless communication. The communication module may be configured to advertise the identity of the vehicle when approaching the EVSE station. Additionally, or alternatively, the communication module may transmit the signal from the EVSE station to the power management device and receive the altered signal from the power management device.

Additionally, the power regulator may comprise a connector module configured to obtain a state of charge from the electric vehicle. The state of charge may comprise a charge progression, a charge capacity and a battery temperature. The communication module may be configured to communicate state of charge to the power management device.

Additionally, or alternatively, the power regulator device may further comprise a rechargeable battery. The power regulator device may further comprise a power module configured to obtain energy from the EVSE cable in at least one configuration mode comprising direct charging or induction charging. The power module may be further configured to trick the EVSE station into supplying power even when no car is charging.

Additionally, or alternatively, the power regulator device may further comprise a disconnection module configured to fully interrupt power distribution from the EVSE station to the electric vehicle.

Although it is commonly used, EVSE stations may employ other communication than PWM to provide communication between the EVSE station and the vehicle. Skilled person in the art will readily recognise that adaptations to other types of communication such as power-line Communication (PLC), controller area network (CAN), power-line modulation and digital signal communication are possible.

In a second aspect, the technique described herein relates to a method for distributing power across a plurality of electric vehicle supply equipment (EVSE) stations using a power distribution device. A load configuration is received at the power distribution device comprising a high-power threshold. A list of EVSE controllers managed by the power distribution device is received, the EVSE controllers comprising power regulator devices and EVSE control planes. A total load of the power distribution device is measured. Upon reaching a high-power threshold the total load may be reduced by communicating a reducing modulation configuration to one or more of the EVSE controllers.

The list of EVSE controllers managed by the power distribution may be obtained by successively powering on and off each of the EVSE stations and measuring changes in the total load of the power distribution device. Additionally, or alternatively, a EVSE controllers may be added to the list of a EVSE stations by scanning an identifier tag on the EVSE controller using a scanning device connected to the power distribution device.

The load configuration may further comprise a high-power recovery threshold such that, upon subsequently falling under the high-power recovery threshold, a restoring modulation configuration may be provided to the one or more EVSE controllers.

Additionally, or alternatively, the load configuration may further comprise a maximum power threshold and a maximum power recovery threshold. At least one vehicle charging from the EVSE controller may be disconnected from the EVSE stations upon reaching the maximum power threshold by communicating a disconnecting modulation configuration to one or more of the EVSE controllers. Upon reaching a maximum power recovery threshold, the vehicle may be reconnected to the EVSE station by and communicating a reconnecting modulation configuration to one or more of the EVSE controllers. Alternatively, the disconnection and reconnection may be achieved by interrupting and restoring power to any one of the EVSE station.

Additionally, or alternatively, a list of downstream power distribution devices managed by the power distribution device may be received. Upon reaching the high-power threshold, the total load may be reduced by reducing the related high-power thresholds of at least one of the downstream power distribution devices.

Additionally, or alternatively, power usage of a power outlets may be reported to a centralized monitoring agent and centralized load configuration may be received from the centralized monitoring agent.

Additionally, or alternatively, load configuration may comprise thresholds described as a function of time, temperature, or both.

In a third aspect, the technique described herein relates to a power distribution device for distributing power across a plurality of electric vehicle supply equipment (EVSE) stations. The power distribution device comprises a storage module, at least one processor module and a network communication module. The storage module may receive a load configuration comprising a high-power threshold and a high-power recovery threshold, and a list of downstream EVSE controllers managed thereby, the EVSE controllers comprising power regulator devices and EVSE control planes. The processor module may compute a power reduction configuration, for at least one of the EVSE controllers upon measuring that a total load has reached the high-power threshold and compute a power restoration configuration, for the at least one of the EVSE controllers upon subsequently reaching a high-power recovery threshold. The network communication module may communicate a modulation configuration to one or more of the downstream EVSE controllers, causing the downstream EVSE stations to consume no more than permitted for the power distribution device.

Additionally, or alternatively, the load configuration may further comprise a maximum power threshold and a maximum power recovery threshold, and the processor module may be further configured to compute an interruption configuration for one or more of the EVSE controllers, upon reaching the maximum power threshold. Upon reaching the maximum power recovery threshold, the processor module may compute a re-establishment configuration, for the one or more of the EVSE controllers.

Additionally, the power distribution device may further comprise at least one power inlet, at least one power outlet and a power measurement module. The power inlet receives power from an upstream power source. The power outlets are connectable to at least one downstream device, the downstream devices comprising the EVSE controllers and downstream power distribution devices managed thereby. The power measurement module may measure a power consumption of individual downstream devices and the total load of the power distribution device.

Additionally, or alternatively, the network communication module may further communicate partial load configurations to one or more downstream power regulator devices powering the EVSE stations therethrough, causing the downstream power regulator devices to consume no more than permitted for the power distribution device. The network communication module may further report the power usage of at least one of the power outlets to a centralized monitoring agent and receive a centralized load configuration from the centralized monitoring agent.

Additionally, or alternatively, the power distribution device may further comprise at least one relay, configured to open or close a circuit between the power inlets and the power outlets, and the load configuration may further comprise a maximum power threshold and a maximum power recovery threshold. The processor module may compute a disconnection configuration causing at least one of the relays to open and interrupt downstream power upon reaching the maximum threshold and compute a reconnection configuration causing at least one of the open relays to close and restore downstream power upon reaching the maximum recovery threshold.

Additionally, or alternatively, the storage module may receive a list of downstream power distribution devices managed by the power distribution device. The processor module may compute a reduced load configuration, for at least one of the downstream power distribution devices, upon reaching the high-power threshold and a restored load configuration, for the at least one of the downstream power distribution devices, upon reaching the high-power recovery threshold. The network communication module may communicate the reduced load configuration and the restored load configuration to the downstream power distribution devices.

In a fourth aspect, the technique described herein relates to a system for managing power consumption comprising a plurality of electric vehicle supply equipment (EVSE) stations. The system comprises a plurality of EVSE stations and one or more power distribution device. The EVSE stations, each being connectable to an electric vehicle, may be configured using a EVSE controller, the EVSE controller comprising a power regulator device or a EVSE control plane. The power distribution device may receive a load configuration comprising a high-power threshold and receive a list of EVSE controllers managed by the power distribution device. The power distribution device may measure a total load of the power distribution device and reduce the total load by communicating a modulation configuration to any one of the EVSE controllers upon measuring that the power distribution device has reached a high-power threshold. The power distribution device may restore the power consumption gradually by communicating a modulation configuration to any one of the EVSE controllers upon reaching a high-power recovery threshold.

Additionally, or alternatively, the load configuration may further comprise a maximum power and a maximum power recovery threshold. Upon reaching the maximum power threshold, the power distribution device may interrupt the charging of any one of the vehicles from the EVSE stations by providing a modulation configuration the EVSE controllers. Upon reaching a maximum power recovery threshold, the power distribution device may restore the charging of any one of the vehicles from the EVSE stations by providing a modulation configuration to the EVSE controllers.

Additionally, or alternatively, the system may further comprise at least one downstream power distribution device powered by the power distribution device. The power distribution device may receive a list of the downstream power distribution devices managed by the power distribution device, configure the load configuration of any one of the downstream power distribution devices upon reaching the high-power threshold and restore the load configuration of any one of the downstream power distribution devices upon reaching the high-power recovery threshold.

Additionally, or alternatively, the system may further comprise a centralized monitoring agent, wherein the power distribution device may report a power usage of the power distribution devices to the centralized monitoring agent and receive a centralized load configuration from the centralized monitoring agent.

### BRIEF DESCRIPTION OF THE DRAWINGS

Further features and exemplary advantages of the present invention will become apparent from the following detailed description, taken in conjunction with the appended drawings, in which:

FIG. 1 is a block diagram depicting an exemplary embodiment of the power regulator device in accordance with the teachings of the present invention;

FIG. 2 is a sequence diagram depicting an exemplary embodiment of the method to adjust the total load of a power distribution device in accordance with the teachings of the present invention;

FIG. 3 is a block diagram depicting an exemplary embodiment of the power distribution device in accordance with the teaching of the present invention;

FIG. 4 is a graph depicting exemplary thresholds used by the power distribution device in accordance with the teaching of the present invention;

FIG. 5 is a state diagram depicting exemplary operating states used by the power distribution device in accordance with the teaching of the present invention; and

FIG. 6 is a block diagram depicting an exemplary embodiment of the power distribution system in accordance with the teaching of the presence invention.

### DETAILED DESCRIPTION

On sites where several vehicles may be charging concurrently, overloading electric circuits may be a concern. Adjusting the load from each connected electric vehicle supply equipment (EVSE) or at least some of them may be desirable in these situations. One aspect of the teachings presented herein relates to a power regulator device 1000 for altering a signal transmitted over an EVSE cable. The power regulator device 1000 may be used to adjust the power consumption of a vehicle attached to a EVSE station when the EVSE station does not provide a compatible control plane. A second aspect of the teachings presented herein relates to a method for distributing power across a plurality of EVSE stations. The method may used to orchestrate power distribution across EVSE stations using power management devices. A third aspect of the teachings presented herein relates to a power distribution device for distributing power across a plurality of EVSE stations. The power distribution device may be used to monitor nodes in the electric circuit and adjust power consumption of downstream devices according to configured thresholds. A fourth aspect of the teachings presented herein relates to a system for managing power consumption comprising a plurality of EVSE stations. The system may be used to safely orchestrate the power distribution of sites providing multiple EVSE stations over a single electric circuit.

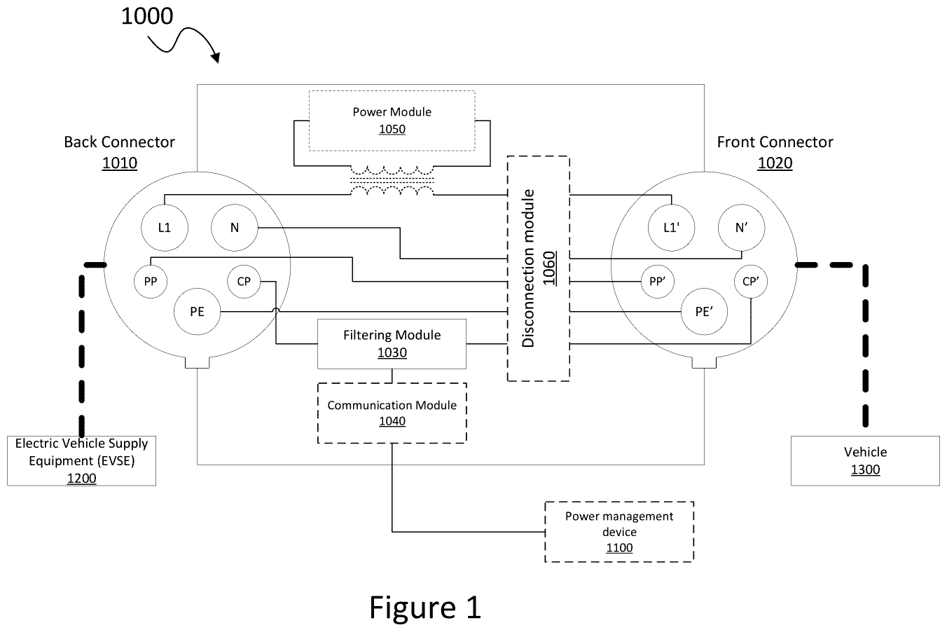

Reference is now made to the drawings in which FIG. 1 depicts an exemplary embodiment of the power regulator device 1000 using SAE J1772 connectivity. SAE J1772 outlets, common in North America are also known as IEC 62196-2-1 Type 1 and carry five connectors. The L1 connector (“AC Line 1”), may carry 120V AC power. The N connector may carry neutral in Level 1 charging mode (“AC Neutral”) or an additional 120V AC power in Level 2 charging mode (“AC Line 2”). The PE connector (“Ground”) may provide a ground. The PP connector (“Proximity Pilot”) may be used to detect the presence of vehicle and signal the latch release button to the vehicle. The CP connector (“Control Pilot”) may be a ±12V 1 kHz square PWM signal used to detect the presence of the vehicle, signal the charging level between the EVSE station and the vehicle, communicate the maximum allowable charging power and control when charging begins and ends. Skilled persons will readily recognize that the power regulator device 1000 is not limited to the shape and layout of the SAE J1772 and other embodiments of the power regulator device 1000 may include different outlet types, such as IEC 62196-2-1 Type 2 commonly used in Europe or the Tesla NACS outlets.

The power regulator device 1000 may be presented as an interconnector that attaches to the EVSE cable. The interconnector may comprise a front component 1020 leading to an electric vehicle 1300 and a back component 1010 leading to an EVSE station 1200. By attaching to the cable as an interconnector, variations of the device may be designed for each type of EVSE cable, including SAE J1772. Skilled persons will readily recognize that, in other embodiments, the device may be integrated within the EVSE station and may, for example, intercept the PWM signal inside the EVSE station, between where the signal is emitted by an integrated circuit (IC) and where it is later amplified before transmission over the cable. In such embodiments, the device may use a ground and a +5V from the EPSE and transform the PWM after it has been generated.

Alternatively, the power regulator device 1000 may be integrated within the vehicle 1300, on the vehicle's charging outlet for example or between the outlet and the vehicle's IC communicating to the EVSE station 1200. When integrated within the vehicle 1300, the power regulator device 1000 may further connect to other interfaces of the vehicle 1300 using a wired (ex. USB™ or OBD2) or wireless (ex. Bluetooth™ or Wifi™) connection. When connected to other interfaces of the vehicle 1300, the power regulator device 1000 may collect additional details about the vehicle, such as the state of charge of the vehicle, which may include one or more of charge progression, capacity, energy stored and temperature of the battery. In this context, the charge progression may be defined as a ratio describing how much energy is stored in the battery of the vehicle over the estimated energy capacity of the battery. In some instances, the energy stored may represent a measurement or an estimated value of available and/or total energy stored in the battery (e.g., in kWh). The state of charge collected by the power regulator 1000 from the vehicle may be communicated back to the power management device 1100 using the communication module 1040. The state of charge received by the power management device 1100 may be useful to prioritize some vehicles over others. For example, vehicles with low charge (e.g., less than 20% or less than 20 kWh) may be prioritized over vehicle with a high charge (e.g., more than 80% or more than 40 kWh) when the electric circuit is at capacity.

Additionally, when integrated within the vehicle 1300, the communication module 1040 may be used to identify the vehicle when the vehicle 1300 is within proximity of the EVSE station. Identification of a proximate vehicle 1300 may be achieved using the communication module 1040 to advertise the presence and/or identity of the vehicle 1300 to the power management device 1100. In this embodiment, the communication module 1040 communicates wirelessly with at least one of the network access points once in range, allowing the power management device 1100 to discover vehicles within proximity and, for example, unlock a EVSE station for the vehicle 1300. This configuration may provide an alternative to using RFID, for example without relying on WAN connectivity.

A filtering module 1030 may intercept the signal from the EVSE station 1200 and output an altered signal towards the electric vehicle 1300, thereby causing the electric vehicle 1300 to consume less power than by outputting the original signal from the EVSE station 1200. When the signal is a pulse-width modulation (PWM), the altered PWM may have a reduced duty cycle compared to the original which, under IEC 62196 standard, communicates lower advertised power capacity. For example, whereas the EVSE station 1200 may advertise 30A by generating a 50% duty cycle PWM, the filter module 1030 may alter the PWM signal so that the duty cycle becomes 25%, hence advertising 15A availability instead to the connected electric vehicle 1300.

A cost-effective filtering module 1030 may, for example, alter the PWM signal by interrupting the original signal using a clock synchronized with the signal and a transistor such as a MOSFET to increase the duration of each low of the duty cycles. Skilled persons will readily recognize that other electronic components may be used to increase the duration of the duty cycle lows, such as digital potentiometers or op-amps for example. In another embodiment, the power regulator device 1000 may further comprise a decoder module, a processor module such as a microcontroller (e.g., an ESP32, a field-programmable gate array (FPGA) . . . ), and an encoder module. The decoder module may decode the PWM signal from the EVSE station, the processor module may be used to compute the altered PWM signal based on the decoded PWM signal and the modulation configuration, and the encoder module may encode the altered PWM signal towards the electric vehicle.

The power regulator device 1000 may further comprise a communication module 1040 configured to communicate with an external power management device 1100. The communication module 1040 and the power management device 1100 may communicate using a wireless communication protocol or wired. Power-line communication (PLC) may be particularly suitable since the devices that need to communicate are typically on the same electric circuit. The communication module 1040 may receive a modulation configuration from the power management device 1100 and transmit measurements back to the power management device 1100. Alternatively, or additionally, the communication module 1040 may transmit the signal from the EVSE station 1200 to the power management device 1100 and receive the altered signal from the power management device 1100.

The power management device 1100 may be the power distribution device described herebelow or a different type of power management device. The power management device 1100 may be located on-site and interconnected using a local area network (LAN). Alternatively, the power management device 1100 may be in a remote location and interconnected over a wide area network (WAN) such as the Internet. In certain embodiments, it may be preferable for the power management device 1100 to be located on-site such that it is not dependant on the WAN.

When co-located on the same LAN, the power regulator device 1000 may probe the network to automatically assign itself to a power management device 1100. In other embodiments, the power management device 1100 may probe the network and assign to itself any discovered power regulator device 1000 power regulator device 1000. The power management device 1100 may comprise a human interface allowing configuration of a unique identifier of the assigned power management device 1100. Conversely, the power regulator device 1000 may further comprise a human interface allowing configuration of a unique identifier of the assigned power management device 1100. In certain embodiments, a third device such as a mobile device or a scanning device, connected to the power regulator device 1000, or to the power management device 1100, or both, is used to assign the power regulator device 1000 to a power management device 1100. When a third device is used for the assignment, the power regulator device 1000 and the power management device 1100 may each be identified by entering a unique identifier, or by scanning an identifier, for example using a bar code or a quick response (QR) code. Alternatively (e.g., when connected using a WAN), the power regulator device 1000 may be assigned to a power management device 1100 using a human interface on the power regulator device 1000 allowing the remote network address of the power management device 1100 to be provided. In certain embodiments, when a third device such as a mobile device or a scanning device is used, the third device may be connected to the power regulator device 1000, to the power management device 1100, or to both and may further be used to assign the power regulator device 1000 to a power management device 1100. When a third device is used for the assignment, the third device may be configured with the power management device 1100 network address and the power regulator device 1000 may be assigned by entering a unique identifier, or by scanning such identifier, for example using a bar code or a QR code. The third device may find and configure the power regulator device 1000 on the local network so that it is assigned to the power management device 1100. Skilled persons will readily recognize that, both in LAN and WAN configuration, other methods may exist to assign the power regulator device 1000 to a power management device 1100, such as using opening a close ranged wireless communication between an external device and the regulation device power regulator device 1000, for example using WIFI™ or Bluetooth™, or opening a wired communication channel with the external device and the power regulator device 1000, for example using USB or ethernet.

The power regulator device 1000 may comprise a power module 1050 configured to obtain energy from the EVSE cable and provide power for operations of the power regulator device. The power module 1050 may capture energy from direct charging or induction charging over the L1 line powered by the EVSE station 1200. In addition, or as an alternative, the power regulator device 1000 may comprise a rechargeable battery and the power module 1050 may be further used to charge the battery. When the EVSE station is not charging a vehicle, the power module 1050 may be further configured to trick the EVSE station into supplying power even when no car is charging. In one embodiment where the EVSE station implements SAE J1772, tricking the EVSA into power provisioning state may be achieved by implementing the SAE J1772 protocol within the power regulator device 1000 while shielding the front component 1020 using a disconnection module 1060. Alternatively, when integrated within the vehicle 1300 and connecting to the vehicle 1300 using a wired connection to generate the state of charge, the power regulator device 1000 may further use the connection for powering the power module 1050. For example, when the power regulator device 1000 connects to the vehicle using a USB™ cable, the USB™ cable may also be used to provide power to the power regulator device 1000.

The disconnection module 1060 may also be used to fully disable power distribution from the EVSE station to the electric vehicle. There are several situations where full disconnection may be desirable for example, when the status of the device is unknown and needs to be monitored before a configuration can be provided or when, despite being configured for lower power consumption, the vehicle continues to draw more power than it is expected to, or when communication with the power management device 1100 is lost.

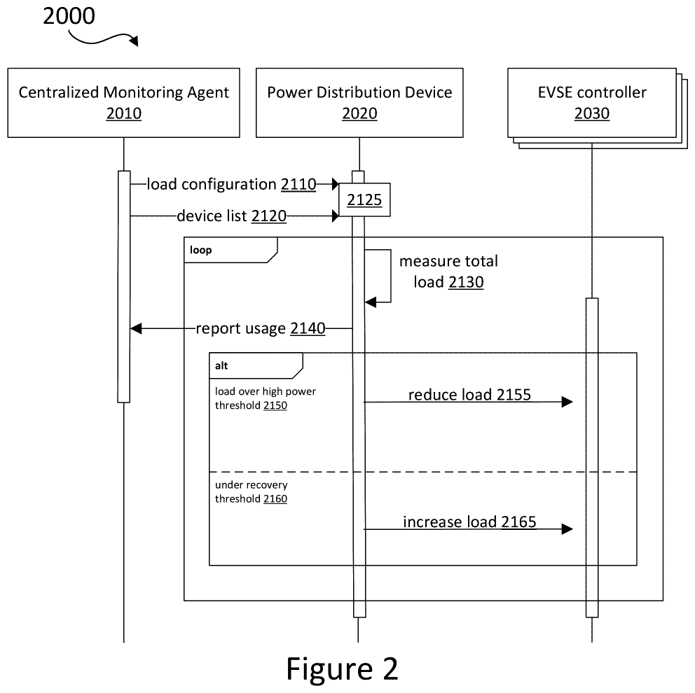

A second aspect of the teachings presented herein relates to a method for distributing power across a plurality of EVSE stations using a power distribution device such as the one presented hereinbelow. The method presented herein may be used to orchestrate the power consumption of the plurality of EVSE stations. FIG. 2 is a nodal operation and flow chart that depicts an exemplary sequence of the method 2000.

To orchestrate the power consumption of the plurality of EVSE stations, a centralized monitoring agent 2010 may configure one or many power distribution devices 2020, each managing and possibly powering one or many EVSE stations (not shown). Adjustments to the power delivered to the charging vehicle are achieved by configuring an EVSE controller 2030 associated with each EVSE stations. In some embodiments, the EVSE station may provide a control plane that allows the EVSE station to be configured over the network. However, in cases where the EVSE station does not provide a control plane, the EVSE controller 2030 may consist of a power regulator device 1000 such as the one described hereabove (e.g., power regulator device 1000). Hence, in a different embodiment, the power distribution devices 2020 may interact directly with EVSE control planes, or with a mixture of EVSE control planes and power regulator devices.

The centralized monitoring agent 2400, the power distribution devices 2020 and the EVSE controllers 2030 may be configured to communicate together on a local network (LAN) or across a wide area network (WAN) such as the internet using wired or wireless connectivity or a mixture of both. Power-line communication may be particularly suitable since the various devices of the method are likely to be powered by the same electric circuit. In the preferred embodiment, the connectivity uses a mesh topology, allowing the EVSE controllers 2030 to connect to the centralized monitoring agent through the power distribution devices 2020 as access point, or allowing multiple power distribution devices 2020 to provide network connectivity to each other.

Initially, a load configuration 2110 and a list 2120 of EVSE controllers 2030 managed by the power distribution device 2020 may be received 2125 by the power distribution device 2020. The load configuration 2110 may comprise power thresholds used to change the operational state of the power distribution device 2020. Although thresholds may comprise of a fixed power value, in certain embodiments, the thresholds are defined as power-over-a-time functions such that short bursts may not necessarily trigger a change in operational state of the power distribution device 2020. Additionally, the load thresholds may further be defined as a function of temperature and/or time, such that the power consumption of the charging vehicles may, for example, be reduced during peak demand in electricity. For example, peak demand in electricity may occur in the morning, in the evenings and in period of extreme cold.

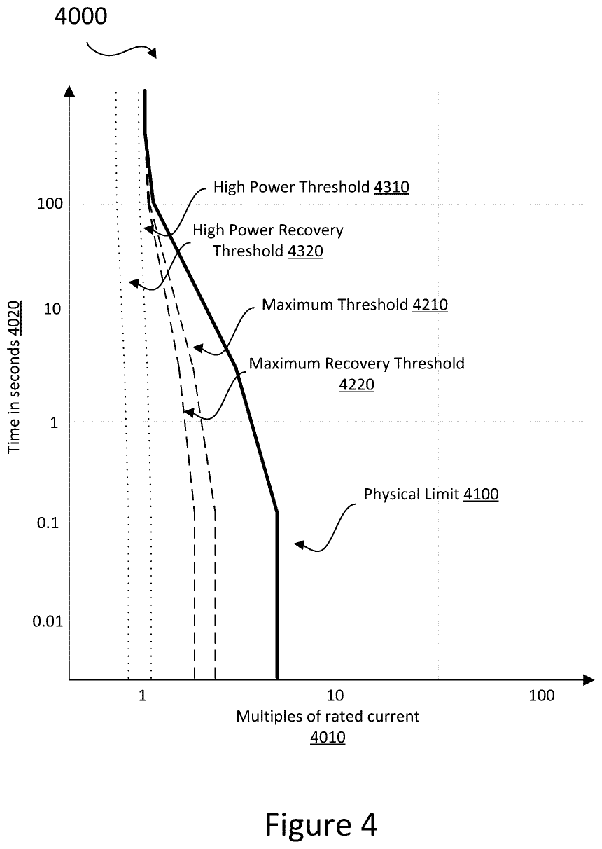

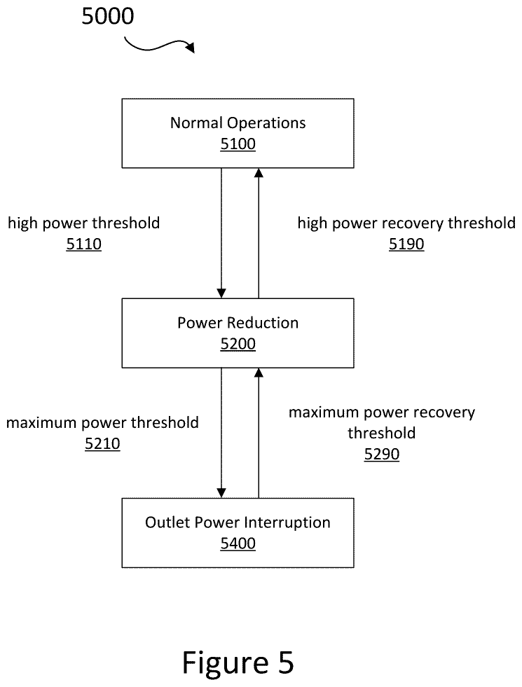

Reference is now concurrently made to FIGS. 2, 4 and 5. The thresholds 4000 may be defined according to the physical limits 4010 of an electrical circuit. A high-power threshold 4310 may be defined to suggest that the circuit is under high load and measures should be initiated to reduce the load. A high-power recovery threshold 4320 may be defined to indicate that the circuit has recovered from high load and no longer requires load reduction measures. A maximum threshold 4210 may be defined to indicate that the circuit has reached capacity and should undertake immediate safety measures. A maximum recovery threshold 4220 may be defined to indicate that the circuit has recovered from reaching capacity and that safety measures may be relaxed. In certain embodiments, the thresholds are defined in function of the multiples of rated current 4100 against time in seconds 4020 and the physical limit 4010 is based on the time current characteristic curves usually provided with circuit breakers. Power-over-a-time function thresholds may allow the maximum rated capacity of the circuit to be exceeded for short period of times. For example, the circuit may provide five times the rated load for a fraction of a second, or twice the rated capacity for one or two seconds or 1.5× the rated load for half a minute.

The thresholds are used by the power distribution device to alter its operating state 5000. When operating below the high-power threshold 5110, the power distribution device operates in normal operation mode 5100. Upon reaching the high-power threshold 5110, the power distribution device transitions to power reduction mode 5200 and communicates a power reducing modulation configuration to the EVSE controller. When the power consumption reaches the high-power recovery threshold 5190, the power distribution device resumes normal operation mode 5100 after transmitting a restoring modulation configuration to the EVSE controller. However, when the power consumption reaches maximum power threshold 5210, the power distribution device undertakes safety measure and interrupts power to the charging vehicles. Interrupting power to the charging vehicle may be achieved by interrupting power to the power outlet 5400 connected to the charging vehicle's EVSE station. In other embodiments, the power management device may attempt to interrupt the power to the charging vehicle by communicating a disconnecting modulation configuration to the EVSE controller. When using the EVSE controller to interrupt the power to the charging vehicle, the EVSE station may remain powered, proving the benefit of a faster recovery for example. After interrupting the power to the charging vehicle, the power consumption is expected to reach the maximum power recovery threshold 5290 and the power distribution device switches back to power reduction mode 5200. When using the EVSE controller to interrupt the power to the charging vehicle, the power distribution device also communicates a reconnecting modulation configuration to the EVSE controller. In the preferred embodiment, the power distribution device first attempts to disconnect the vehicle through the EVSE controller and proceeds to interrupt the power through the outlet if power consumption does not quickly reach the maximum power recovery threshold 5290 as extra safety.

In addition to receiving 2025 the load configuration 2110, a list 2120 of EVSE controllers 2030 managed or powered by the power distribution device 2020 may also be communicated to the power distribution device 2020. The list 2120 may, as an example, be obtained by successively powering on and off each of the EVSE controllers 2030 and measuring the change in the total load of the power distribution device. A centralized monitoring agent 2010 configured to communicate with the EVSE controllers 2030 and with the power distribution devices 2020 may signal a startup and shutdown sequence on each of the EVSE controllers 2030 and monitor for change in power consumption of each outlet of the power distribution device to construct a connectivity tree from which the list 2120 may be derived.

The EVSE controllers 2030 may also be added by scanning a corresponding identifier tag using a mobile or a scanning device connected to the power distribution device 2020. The identity of the EVSE controllers 2030 associated with a tag identifier scanned may be communicated to the power distribution device 2020 so that the corresponding EVSE controllers 2030 may be added to the list 2120.

Alternatively, or additionally, when the using power-line communication, the EVSE controllers 2030 may be discovered by probing each of the power distribution outlets of the power monitoring device.

A total load of the power distribution device 2020 is measured 2130. Upon reaching 2150 a high-power threshold, the total load may be reduced by communicating 2155 a reducing modulation configuration to one or more of the EVSE controllers 2030. The scenario where a high-power threshold 4310 is reached may correspond, for example, to when multiple EVSE stations are charging a high capacity. The communication 2155 of a reducing modulation configuration, once communicated 2155 to the EVSE controllers 2030, may cause the EVSE controllers 2030 to advertise (not shown) lower power capabilities of the charging vehicle and cause the charging vehicles to draw less power and reduce charging demand.

Upon subsequently reaching 2160 the high-power recovery threshold, a restored restoring configuration may be provided 2165 to the one or more EVSE controllers 2030. Restoring the modulation configuration of the EVSE controllers 2030 may cause the EVSE station to advertise (not shown) higher charging capacity and cause the charging vehicles to draw more power and reach faster charging rates.

When the method 2000 fails to reduce the power consumption and the power consumption reaches a maximum power threshold, one EVSE controllers be configured to fully interrupt the charging of the vehicle, or the power monitoring device may interrupt power to the power outlet connected to the EVSE station. Interrupting power to the EVSE station may be used as a safety measure to quickly reduce the power drawn from the power distribution device 2020, in anticipation of reaching the physical limit of the circuit. Upon reaching a maximum power recovery threshold, the power distribution device 2020 may resume power to the power outlet connected to the EVSE station and/or may transmit a reconnecting modulation configuration to the EVSE controllers 2030, signaling to resume charging the vehicle.

Multiple power distribution devices 2020 may be used on a single EVSE station site. Each distribution devices 2020 of a charging site may be connected to an independent electrical circuit or be configured as nodes of an electric circuit tree. When configured as nodes of an electric circuit tree, the load configuration may reduce the capacity of each power distribution devices 2020 below the actual physical capacity of their underlying circuit, such that downstream power distribution devices 2020 may not overload upstream power distribution devices 2020.

To orchestrate the tree of power distribution devices 2020, a list of downstream power distribution devices managed by the power distribution device 2020 may be received 2125. Upon reaching 2150 the high-power threshold, the power distribution device 2020 may reduce the power consumption of at least once of the downstream power distribution device by communicating a reduced load configuration to the downstream the power distribution device.

In one embodiment, the capacity configuration of the power distribution devices may be delegated to the central monitoring agent 2010. The centralized monitoring agent 2010 may receives power measurements of each power inlet and outlet of the power distribution devices 2020 and adjust the capacity configuration of each node taking into account the complete topology of the power distribution devices.

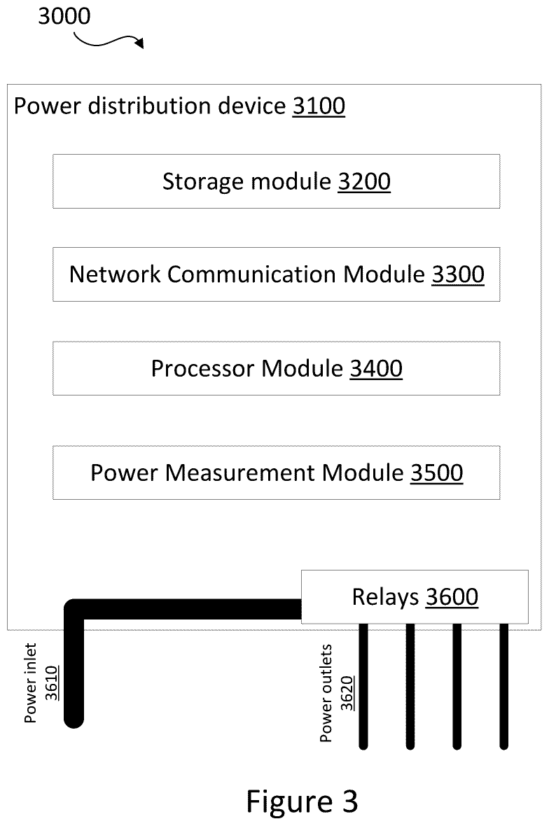

A third aspect of the teachings presented herein relates to a power distribution device 3100 in a system 3000 for distributing power across a plurality of EVSE stations. Reference is now made to the drawings in which FIG. 3 depicts an exemplary embodiment of the power distribution device 3100. The power distribution device 3100 may comprise a network communication module 3300, a storage module 3200, and at least one processor module 3400.

The network communication module 3300 may communicate with EVSE controllers (e.g., comprising EVSE control planes or power regulator devices as exemplified hereinabove) and with other power downstream and upstream power distribution devices. In addition, the network communication module 3300 may also communicate with a central monitoring agent or mobile devices to receive configurations and provide monitoring measurements. The monitoring measurements reported to the central monitoring agent or mobile device may include, for example, instantaneous and historical power usage of the power outlets. The network communication module 3300 may further receive the signal from the EVSE controller and transmit an altered signal or modulation configurations to the EVSE controller in order to adjust the power consumption of the EVSE station. The network communication module 3300 may also provide access point to the network for other devices, including EVSE controllers and other power distribution devices, and allowing the creation of a mesh network.

The storage module 3200 may receive a load configuration comprising power thresholds, a list of EVSE stations managed thereby as well as a list of other downstream power distribution devices managed and/or powered by the power distribution device.

The power thresholds stored on the storage module 3200 are used to change the operating state of the power distribution device 3100. For example, a high-power threshold may be configured to indicate that power distribution device 3100 should initiate consumption reduction measures. A maximum power threshold may be configured to indicate that the power distribution device 3100 has reached maximum capacity and should undertake immediate safety measures. A maximum power recovery threshold may be configured to recover from the maximum power safety measures. A high-power recovery threshold may be configured to reverse some of the consumption reduction measures. In the preferred embodiment, each threshold may be defined as a power-over-a-time functions, as described hereabove.

Based on the operation state, the processor module 3400 module may compute configurations for at least one of the EVSE controller or downstream power distribution devices. Upon measuring with the power measurement module 3500 that the power consumption has reached the high-power threshold, the processor module 3400 may compute a power reducing modulation configuration, for at least one of the EVSE controller 2030. Upon measuring that the power consumption has reached the maximum power threshold, the processor module 3400 may compute a power disconnecting modulation configuration, for the at least one of the EVSE controller.

The processor module 3400 may compute a disconnecting modulation configuration for one or more of the EVSE controllers, upon reaching a maximum power threshold and compute a reconnecting modulation configuration upon reaching a maximum power recovery threshold. The modulation configurations may be transmitted using the network communication module 3300 to one or more downstream EVSE controllers, causing the downstream power regulator devices to consume no more than permitted for the power distribution device.

When recovering from a power outage, the power distribution device 3100 may resume in a maximum power operating state with safety measures enabled similar to when maximum power threshold has been reached. Alternatively, when power measurement by the power measurement module 3500 are persisted to the storage module 3200, the power distribution device 3100 may resume in last known operating state.

The power distribution device 3100 may be a device independent of the electrical circuit communicating with a power measurement module 3500 connected to the electrical circuit. In the preferred embodiment, however, the power distribution device 3100 may further comprise at least one power inlet 3610, at least one power outlet 3620, the power measurement module 3500 and may also contain a relay 3600 for each of the power outlet 3620. In this embodiment, the power inlet 3610 receives power from an upstream power source and the power outlets 3620 are connectable to at least one downstream device such as an EVSE station, a EVSE controller or another power distribution device. In this embodiment, the power distribution device behaves like a smart power strip and may contain other components commonly found on power strip devices such as varistors (metal oxide varistors for example) and gas discharge tubes for surge protection, or capacitors for noise filtering.

The power measurement module 3500 may monitor a power consumption of individual power outlet 3620 and a total load of the power distribution device at the power inlet 3610. The measurement of power consumption may be used to change the operating state of the power distribution device 3100 according to the threshold configured in the storage module 3200.

The relay 3600 may be configured to open or close a circuit between the power inlet 3610 and the power outlets 3620. Interrupting the power of one or many power outlets 3620 may be desirable when the maximum power threshold is reached and other attempts to reduce the power consumption have failed. For safety reasons, in the preferred embodiment, the relays 3600 are initialized in open state when the power distribution device 3100 is started or resumes from a power outage and remain open until the configuration has been stored in the storage module 3200. In situations where power was interrupted from an upstream power distribution device, resuming with relays 3600 in open state gives the opportunity to the resumed power distribution device to reconnect to the network and receive a configuration update before resuming to draw power from the electric circuit.

When open, relays 3600 may be closed successively, one by one, rather than concurrently, with a short pause between each, allowing for measurements from the power measurement module 3500 to ensure the electric circuit is not suddenly overloaded. Similarly, when recovering from a power failure, the relays 3600 may be closed successively rather than concurrently in order to avoid a surge on the electric circuit that might occur should all devices be powered at the same time.

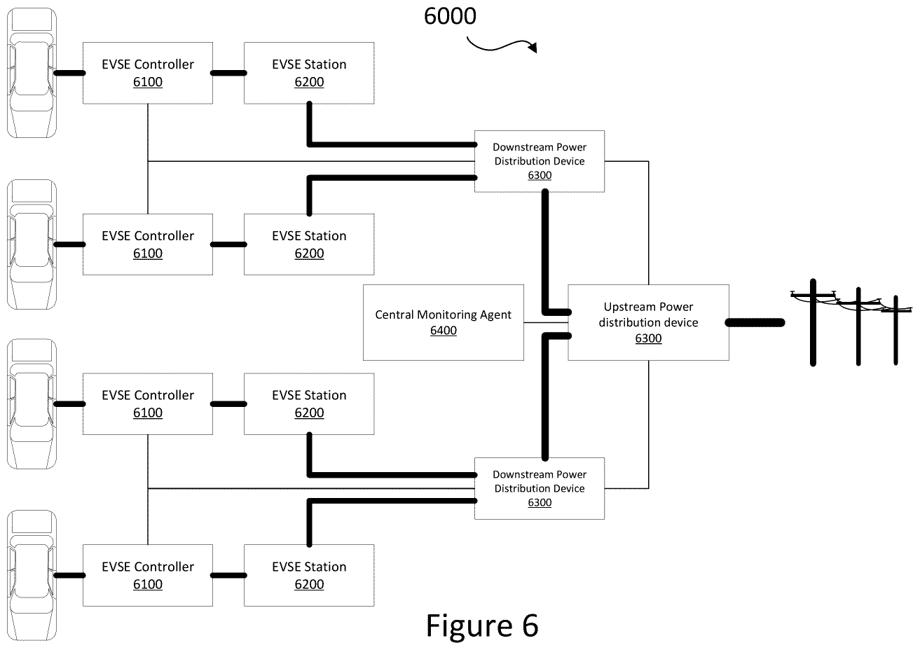

A fourth aspect of the teachings presented herein relates to a system 6000 for managing power consumption comprising a plurality of EVSE stations. The system may be used to monitor and orchestrate the power consumption of the plurality of EVSE stations. Reference is now made to FIG. 6. The system 6000 comprises EVSE stations 6200, each being connectable to an electric vehicle, and one or more power distribution device 6300 similar or identical to the one described hereabove. Configuration of the EVSE station is achieved through EVSE controllers 6100. In cases where the EVSE stations do not provide a control plane compatible with the power distribution devices 6300, a power regulator device (e.g., similar to 1000 described hereabove) may be used as a EVSE controller 6100. The system may further comprise a central monitoring agent 6400.

The power distribution device 6300 may receive a load configuration comprising power thresholds, receive a list of EVSE stations powered by the power distribution device, measure a total load of the power distribution device, reduce the total load by communicating a reducing modulation configuration to any one of the EVSE controller 6100 upon measuring that the power distribution device has reached a high-power threshold and restore the power consumption gradually by communicating a restoring modulation configuration to any one of the EVSE controller 6100 upon reaching a high-power recovery threshold. The power distribution device may also disconnect charging vehicles upon reaching a maximum power threshold by communicating a disconnecting modulation configuration to the EVSE controller or by interrupting power to its power outlets and reconnect the charging vehicle upon reaching a maximum power recovery threshold by communicating a reconnecting modulation configuration to the EVSE controllers or by restoring power to its power outlets.

The power interruption and power restoration strategy may vary from one embodiment to another. The interruption may consist of communicating a disconnecting configuration to the downstream EVSE controller 6100, allowing the EVSE controller 6100 and EVSE stations 6200 to still receive power for standby operations and to reconnect quickly. Alternatively, or additionally, the power interruption may consist of completely interrupting the power to the EVSE station and restoring it later, causing the EVSE station to be fully powered down and to restart once powered back on.

The system 6000 may further comprise at least one downstream power distribution device 6300 powered by an upstream power distribution device 6300. The power distribution device may receive a list of the downstream power distribution devices 6300 and may configure any of the registered downstream power distribution device 6300 upon reaching the high-power threshold, a high-power recovery threshold, a maximum power threshold or a maximum recovery threshold.

Additionally, or alternatively, the system 6000 may further comprise a centralized monitoring agent 6400, wherein the power distribution device may report a power usage of at least one of the power outlets to the centralized monitoring agent 6400 and receive a centralized configuration from the centralized monitoring agent 6400.

The EVSE controller 6100 and the power distribution devices 6300 may communicate through one or more dedicated network access point such network gateway or router with the central monitoring agent 6400 over a WAN, allowing the central monitoring agent 6400 to be configured within an external infrastructure, including a cloud infrastructure. In certain embodiments, the power distribution devices 6300 may also act as both network client and access point, allowing for the devices to connect using a mesh topology and hence providing multiple access points into the network. In certain embodiments, the central monitoring agent 6400 is hosted on-site within a LAN, such that the system 6000 is resilient to external network outages. The mesh network may be established over wired or wireless network, including for example, ethernet, power-line or WIFI™ protocols.

What is claimed is:

1. A power regulator device for altering a signal transmitted over an electric vehicle supply equipment (EVSE) cable, the power regulator device comprising:
an interconnector attaching to the EVSE cable having a front component leading to an electric vehicle and a back component leading to an EVSE station;
a storage module configured to receive a modulation configuration; and
a filtering module configured to:
intercept the signal from the EVSE station; and
output an altered signal according to the modulation configuration towards the electric vehicle, thereby causing the electric vehicle to consume less power than by outputting the signal from the EVSE station.

2. The power regulator device of claim 1, wherein the signal is a pulse-width modulation (PWM) signal, and the filtering module is further configured to alter the PWM signal by reducing duty cycles of the PWM signal.

3. The power regulator device of claim 1, further comprising:
a decoder module for decoding the signal from the EVSE station into a decoded signal;
a processor module for computing the altered signal based on the decoded signal and the modulation configuration; and
an encoder module for encoding the altered signal towards the electric vehicle.

4. The power regulator device of claim 1, further comprising a communication module configured to communicate with a power management device, the power management device comprising a power distribution device or a central monitoring agent, and the communication module being configured to receive the modulation configuration therefrom and to transmit measurements thereto.

5. The power regulator device of claim 4, wherein the communication module is further configured to advertise the identity of the vehicle when approaching the EVSE station.

6. The power regulator device of claim 4, wherein the communication module is further configured to:
transmit the signal from the EVSE station to the power management device; and
receive the altered signal from the power management device.

7. The power regulator device of claim 4, further comprising a connector module configured to obtain, from the electric vehicle, a state of charge comprising at least one of a charge progression, a charge capacity, and a battery temperature and wherein the communication module is further configured to communicate the state of charge to the power management device.

8. The power regulator device of claim 7, further comprising a power module configured to obtain energy from the EVSE cable in at least one configuration mode comprising direct charging and induction charging and wherein the power module is configured to trick the EVSE station into supplying power even when no car is charging.

9. The power regulator device of claim 1, further comprising a disconnection module configured to fully interrupt power distribution from the EVSE station to the electric vehicle.

10. A method for distributing power across a plurality of electric vehicle supply equipment (EVSE) stations using a power distribution device, the method comprising:
receiving a load configuration at the power distribution device, the load configuration comprising a high-power threshold;
receiving a list of EVSE controllers managed by the power distribution device, the EVSE controllers comprising power regulator devices and EVSE control planes;
measuring a total load of the power distribution device; and
reducing the total load by communicating a reducing modulation configuration to one or more of the EVSE controllers upon reaching the high-power threshold.

11. The method of claim 10, wherein the load configuration further comprises a high-power recovery threshold, the method further comprising providing a restoring modulation configuration to the one or more EVSE controllers upon falling under the high-power recovery threshold.

12. The method of claim 10, wherein the load configuration further comprises a maximum power threshold and a maximum power recovery threshold, the method further comprising:
disconnecting at least one vehicle charging from one of the EVSE stations by communicating a disconnecting modulation configuration to one or more of the EVSE controllers upon reaching the maximum power threshold; and
reconnecting the disconnected vehicle by communicating a reconnecting modulation configuration to corresponding EVSE controllers upon reaching the maximum power threshold upon reaching the maximum power recovery threshold.

13. The method of claim 10, further comprising:
receiving a list of downstream power distribution devices managed by the power distribution device; and
reducing the total load by reducing related high-power thresholds of at least one of the downstream power distribution devices upon reaching the high-power threshold.

14. The method of claim 10, further comprising:
reporting a power usage of a power outlets to a centralized monitoring agent; and
receiving a centralized load configuration from the centralized monitoring agent.

15. The method of claim 10, wherein the load configuration comprises thresholds described as a function of time, temperature, or both.

16. A power distribution device for distributing power across a plurality of electric vehicle supply equipment (EVSE) stations, comprising:
a storage module configured to:
receive a load configuration comprising a high-power threshold and a high-power recovery threshold; and
receive a list of downstream EVSE controllers managed thereby, EVSE controllers comprising power regulator devices and EVSE control planes; and
at least one processor module configured to:
compute a power reduction configuration for at least one of the downstream EVSE controllers upon measuring that a total load has reached the high-power threshold; and
compute a power restoration configuration for the at least one of the EVSE controllers upon subsequently reaching the high-power recovery threshold.
a network communication module configured to:
communicate a modulation configuration to one or more of the downstream EVSE controllers, causing the downstream EVSE stations to consume no more than permitted for the power distribution device.

17. The power distribution device of claim 16, wherein the load configuration further comprises a maximum power threshold and a maximum power recovery threshold and wherein the processor module is further configured to:
compute an interruption configuration for one or more of the EVSE controllers upon reaching the maximum power threshold; and
compute a re-establishment configuration the one or more of the EVSE controllers upon reaching the maximum power recovery threshold.

18. The power distribution device of claim 16, further comprising:
at least one power inlet receiving power from an upstream power source;
at least one power outlet connectable to at least one downstream device, the downstream devices comprising the downstream EVSE controllers and downstream power distribution device managed thereby; and
a power measurement module configured to:
measure a power consumption of the downstream devices; and
measure the total load of the power distribution device.

19. The power distribution device of claim 18, further comprising at least one relay configured to open or close a circuit between the at least one power inlet and the at least one power outlet, and wherein:
the load configuration further comprises a maximum power threshold and a maximum power recovery threshold; and
the processor module is further configured to:
compute an interruption configuration causing at least one relay to open and interrupt downstream power upon reaching the maximum threshold; and
compute a restoration configuration causing at least one open relay to close and restore downstream power upon reaching the maximum recovery threshold.

20. The power distribution device of claim 16, wherein:
the storage module is further configured to:
receive a list of downstream power distribution devices managed thereby; and
the processor module is further configured to:
compute a reduced load configuration for at least one of the downstream power distribution devices upon reaching the high-power threshold; and
compute a restored load configuration for at least one of the downstream power distribution devices upon reaching the high-power recovery threshold; and
the network communication module is further configured to:
communicate the reduced load configuration and the restored load configuration to the downstream power distribution devices.

21. A system for managing power consumption of electric vehicle supply equipment (EVSE) stations comprising:
a plurality of EVSE stations, each being connectable to an electric vehicle and configured using a EVSE controller, the EVSE controller comprising a power regulator device or a EVSE control plane;
one or more power distribution devices configured to:
receive a load configuration comprising a high-power threshold and a high-power recovery threshold;
receive a list of EVSE controllers managed by the power distribution device;
measure a total load of the power distribution device;
reduce the total load by communicating a modulation configuration to at least one of the EVSE controllers upon measuring that the power distribution device has reached the high-power threshold; and
restore the power consumption gradually by communicating a modulation configuration to the at least one EVSE controller upon reaching the high-power recovery threshold.

22. The system of claim 21, wherein:
the load configuration further comprises a maximum power threshold and a maximum power recovery threshold; and
the power distribution device is further configured to:
interrupt charging of one or more of the vehicles from the EVSE stations upon reaching the maximum power threshold by providing a modulation configuration to the EVSE controllers; and
restore the charging of the one or more vehicles from the EVSE stations upon reaching the maximum power recovery threshold by providing a modulation configuration the EVSE controllers.

23. The system of claim 21, further comprising at least one downstream power distribution device managed by the power distribution device and further configured to, wherein the power management device is further configured to:
receive a list of the downstream power distribution devices managed by the power distribution device;
configure the load configuration of any one of the downstream power distribution devices upon reaching the high-power threshold; and
restore the load configuration of any one of the downstream power distribution devices upon reaching the high-power recovery threshold.
